(19) United States
(12) Patent Application Publication
(10) Pub. No.: US 2018/0059970 A1
(43) Pub. Date: Mar. 1, 2018

(54) STORAGE DEVICE AND METHOD OF WRITING DATA INTO STORAGE DEVICE

(71) Applicant: KABUSHIKI KAISHA TOSHIBA, Tokyo (JP)

(72) Inventor: Masahide TAKAZAWA, Yokohama Kanagawa (JP)

(21) Appl. No.: 15/445,871

(22) Filed: Feb. 28, 2017

(30) Foreign Application Priority Data
Aug. 26, 2016 (JP) 2016-165867

(51) Int. Cl. G06F 3/06

(52) U.S. Cl. CPC G06F 3/0619; G06F 3/0622; G06F 3/0685; G06F 3/0656; G06F 3/0659

(57) ABSTRACT

A storage device includes a nonvolatile memory device that includes a storage area and a circuit configured to measure a write time required for writing data into the storage area and compare the measured write time with a threshold value, and a controller configured to prohibit the data from being written into the storage area in which the measured write time is determined to be longer than the threshold value by the circuit of the nonvolatile memory.

### CROSS-REFERENCE TO RELATED APPLICATION

This application is based upon and claims the benefit of priority from Japanese Patent Application No. 2016-165867, filed Aug. 26, 2016, the entire contents of which are incorporated herein by reference.

### FIELD

Embodiments described herein relate generally to a storage device and a method of writing data into the storage device.

### BACKGROUND

A storage device includes a power loss protection (PLP) function to protect against data loss when an abnormality unexpectedly occurs in a main power source. When the abnormality occurs in the main power source, the storage device saves write data that is temporarily stored in a volatile memory (unwritten data) and management information of this unwritten data in a nonvolatile memory using the PLP function. When the main power source is recovered, the storage device can restore the unwritten data saved in the nonvolatile memory to the volatile memory based on the management information saved in the nonvolatile memory. That is, even when the abnormality occurs in the main power source, the unwritten data and the management information of the unwritten data are saved in the nonvolatile memory, and thus, the storage device can protect against the loss of the unwritten data.

In the nonvolatile memory, programming (writing) of the data into a part of the storage area of the nonvolatile memory and erasing are typically repeated many times, and thus, memory cells included in the storage area deteriorate. Therefore, in the nonvolatile memory, in accordance with an increase in the number of writings of the data into the part of the storage area, the time required for writing the data into the storage area increases, that is, a speed of writing the data into the storage area becomes lower than the speed of writing in a state in which the memory cells are not deteriorated. As described above, since the speed of writing data into the part of the storage area becomes lower, in the nonvolatile memory, an error or the like occurs in which data of a certain data amount cannot be written into the storage area within a certain time.

### DESCRIPTION OF THE DRAWINGS

FIG. 1 is a block diagram illustrating a configuration of a storage device according to an embodiment.

FIG. 2 is a schematic diagram illustrating an example of a nonvolatile memory according to the embodiment.

FIG. 3 is a diagram illustrating an example of a configuration diagram for determining a speed of writing the data into a memory cell portion according to the embodiment.

FIG. 4A is a diagram illustrating a timing chart in which a signal level of the write signal is LOW at a timing when a signal level of the reference signal transitions from HIGH to LOW, and FIG. 4B is a diagram illustrating a timing chart in which the signal level of the write signal is HIGH at a timing when the signal level of the reference signal transitions from HIGH to LOW.

FIG. 5 is a diagram illustrating an example of the speed of writing with respect to the number of writings in one storage area of the memory cell portion.

FIG. 6 is a flowchart illustrating an example of writing into the nonvolatile memory in the storage device according to the embodiment.

FIG. 7 is a flowchart illustrating an example of determining whether or not a storage area in a nonvolatile memory included in a storage device according to a modification example is usable.

FIG. 8 is a block diagram illustrating a configuration of a storage device according to a second embodiment.

### DETAILED DESCRIPTION

Embodiments provide a storage device and a method of writing data into the storage device in a manner that provides improved protection against data loss.

In general, according to one embodiment, a storage device includes a nonvolatile memory device that includes a storage area and a circuit configured to measure a write time required for writing data into the storage area and compare the measured write time with a threshold value, and a controller configured to prohibit the data from being written into the storage area in which the measured write time is determined to be longer than the threshold value by the circuit of the nonvolatile memory.

Hereinafter, embodiments will be described with reference to the drawings.

### First Embodiment

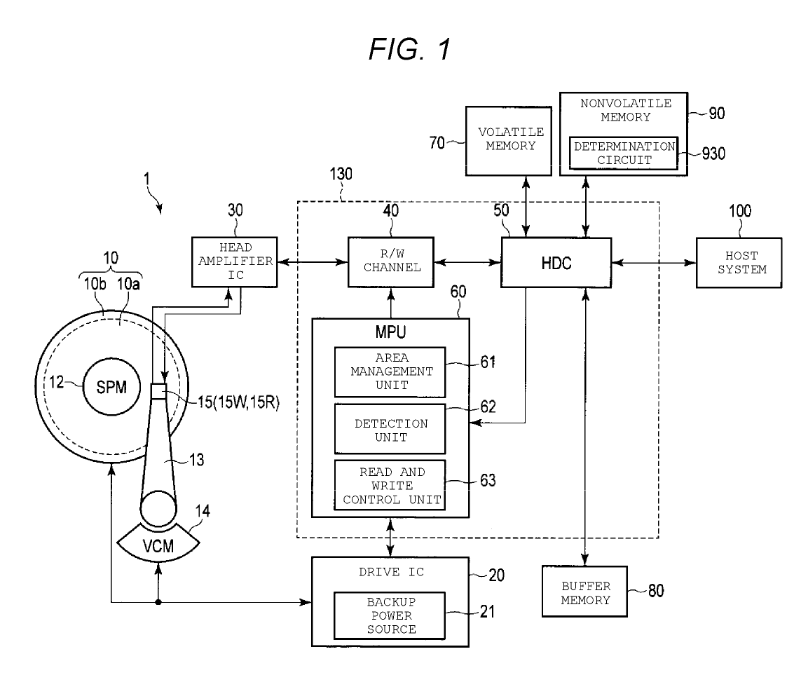

FIG. 1 is a flowchart illustrating a configuration of a storage device 1 according to a first embodiment.

The storage device 1 according to the present embodiment is a magnetic disk device, for example, a hard disk drive (HDD). The storage device 1 includes a head disk assembly (HDA), a driver IC20, a head amplifier integrated circuit (hereinafter, referred to as a head amplifier IC) 30, a volatile memory 70, a buffer memory (buffer) 80, a nonvolatile memory 90, and a system controller 130 that is a one-chip integrated circuit. In addition, the storage device 1 is connected to a host system (host) 100.

The HDA includes a magnetic disk (hereinafter, referred to as a disk) 10, a spindle motor (SPM) 12, an arm 13 on which a head 15 is mounted, and a voice coil motor (VCM) 14. The disk 10 rotates by the spindle motor 12. The arm 13 and the VCM 14 makes up an actuator. The actuator controls the movement of the head 15 mounted on the arm 13 up to a predetermined position on the disk 10 using the drive from the VCM 14. The number of provided disks 10 and the heads 15 may be equal to or more than two.

In the disk 10, a storage area 10a for user data and a system area 10b in which information necessary for the system management (i.e., system data) is written are allocated.

The head 15 includes a write head 15W and a read head 15R mounted on a slider with the slider as a main body. The read head 15R reads data stored in a data track on the disk 10. The write head 15W writes the data on the disk 10.

The driver IC 20 controls the drive of the SPM 12 and the VCM 14 in accordance with the control by the system controller 130 (specifically, MPU 60 described below). Furthermore, when electric power supplied from a power source of the storage device 1, for example, an external power source (hereinafter, referred to as a main power source) is cut-off or lowered, that is, when an abnormality occurs in the main power source, the driver IC 20 can supply the electric power. The driver IC 20 includes, for example, a backup power source 21. The backup power source 21 uses a back electromotive force of the SPM 12 for generating the backup electric power. The backup power source 21 may use a capacitor which is charged by the main power source for generating the backup electric power. When an abnormality occurs in the main power source, the backup power source 21 supplies the electric power necessary for the saving operation of the volatile data remaining in the storage device 1. The backup power source 21 supplies the electric power at least to the system controller 130.

The head amplifier IC 30 includes a read amplifier and a write amplifier. The read amplifier amplifies a read signal read out by the read head 15R and transmits the amplified signal to a read and/or write (R/W) channel 40 in the system controller 130. The write driver transmits a write current corresponding to the write data output from the R/W channel 40 to the write head 15W.

The volatile memory 70 is a semiconductor memory that loses data stored therein when the supply of the electric power thereto is cut off. The volatile memory 70 stores various data items or the like necessary for processing in each unit in the storage device 1. The volatile memory 70 is, for example, a Synchronous Dynamic Random Access Memory (SDRAM).

The buffer memory 80 is a semiconductor memory that temporarily stores the data or the like transmitted and received between the disk 10 and the host system 100. The buffer memory 80 may be arranged integrally with the volatile memory 70. The buffer memory 80 is, for example, a Dynamic Random Access Memory (DRAM), a Static Random Access Memory (SRAM), a Ferro-electric Random Access memory (FeRAM), and a Magneto-resistive Random Access Memory (MRAM).

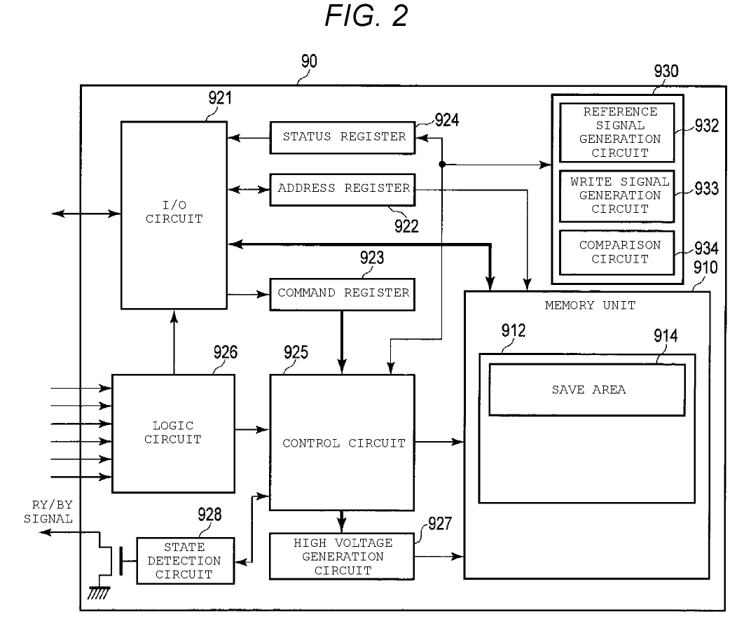

The nonvolatile memory 90 is a semiconductor memory that is able to retain the data stored therein even when the electric power supply thereto is cut off. The nonvolatile memory 90 is, for example, a flash memory. The nonvolatile memory 90 may be a NOR type flash memory or a NAND type flash memory. The nonvolatile memory 90 includes at least a determination circuit 930 and detailed structure thereof will be described using FIG. 2.

FIG. 2 is a schematic diagram illustrating an example of the nonvolatile memory 90 according to the present embodiment.

The nonvolatile memory 90 includes a memory unit 910, an input-output (I/O) circuit 921, an address register 922, a command register 923, a status register 924, control circuit 925, a logic circuit 926, a high voltage generation circuit 927, a state detection circuit 928, and the determination circuit 930.

The memory unit 910 includes a memory cell portion 912. The memory cell portion 912 includes a plurality of memory cells in which the data items are stored, and includes a storage area having save areas 914. The save area 914 is a storage area that temporarily writes the data (hereinafter, referred to as “save”) when the abnormality occurs in the main power source.

The I/O circuit 921 executes data transmission and reception or the like between outside of the nonvolatile memory 90 and each unit inside of the nonvolatile memory 90. For example, the I/O circuit 921 executes the transmission and reception of the data between outside and the memory unit 910, and transfers commands from the outside or the logic circuit to the command register 923. Furthermore, the I/O circuit 921 outputs a status from the status register 924 to the outside. The address register 922 temporarily stores address information or the like. The command register 923 temporarily stores command information that selects a software program (write) operation, a read operation, and an erase operation. The status register 924 temporarily stores status information (hereinafter, simply referred to as status) indicating a status of the memory cell portion 912. The status includes, for example, information indicating whether a part of the storage area (memory block) in the memory cell portion 912 can be used or not, that is, for example, a status bit. The status register 924 transfers the status to the outside via the I/O circuit 921. The control circuit 925 controls various operations such as the software program operation, the read operation, and the erase operation with respect to the memory cell portion 912. The logic circuit 926 receives various control signals and controls the operation of the control circuit 925 based on the control signals. The high voltage generation circuit 927 is used at the time of software program operation, and generates a high voltage which is higher than the power source voltage to the nonvolatile memory 90 and supplies the high voltage to the memory unit 910. The state detection circuit 928 detects a current state of the nonvolatile memory 90 and transfers the data relating to the current state to the outside. For example, the state detection circuit 928 outputs a BY signal indicating a Busy state (BY: busy) when the nonvolatile memory 90 is in operation and outputs an RY signal indication a Ready state (RY: ready) when the nonvolatile memory 90 is in stand-by state. The state detection circuit 928 can output the BY signal and the RY signal to the below-described determination circuit 930 via the control circuit 925.

The determination circuit 930 includes a reference signal generation circuit 932, a write signal generation circuit 933, and a comparison circuit 934. The determination circuit 930 measures a time (hereinafter, referred to as a write time) it takes for data of a certain data amount to be written into the part of the storage area in the memory cell portion 912, and determines whether the measured write time is longer or shorter than a reference write time (hereinafter, referred to as a reference time or a threshold value), and then, determines whether the speed of writing the data of a certain data amount into the part of the storage area in the memory cell portion 912 is higher or lower than a reference speed of writing (hereinafter, referred to as a speed of writing). The speed of writing is represented by the following equation: speed of writing=a certain amount of write data/write time. Therefore, the reference speed is represented by the following equation: reference speed=a certain amount of write data/reference time. Hereinafter, for the convenience in describing, in some cases, the data of a certain data amount is simply referred to as data.

For example, the determination circuit 930 detects a signal (start signal) indicating that the data writing into the part of the storage area in the memory cell portion 912 is started and a signal (completion signal) indicating that the data writing is completed, and then, measures the write time for writing the data into the part of the storage area. The start signal and the completion signal are pulse signals or level signals. The determination circuit 930 determines whether the measured write time is longer or shorter than the reference time (the threshold value). When the write time is shorter than the reference time, the determination circuit 930 outputs a signal (hereinafter, referred to as a normal signal) indicating that the speed of writing is faster than the reference speed to the status register 924 or the like. On the other hand, when the write time is longer than the reference time, the determination circuit 930 outputs a signal (hereinafter, referred to as a warning signal) indicating that the speed of writing is slower than the reference speed to the status register 924. The reference time (the threshold value) may be the same number in all the storage area in the memory cell portion 912 or may be values different from each other for each of the plurality of partitioned storage areas in the memory cell portion 912.

The reference signal generation circuit 932 receives the start signal, and outputs a signal (hereinafter, referred to as a reference signal) corresponding to the reference time (the threshold value) used for determining whether the speed of writing the data into the part of the storage area in the memory cell portion 912 is low or high. For example, as the reference signal, the reference signal generation circuit 932 outputs a signal that rises (becomes High: H) in accordance with the reception of the start signal and falls (becomes Low: L) from the time of receiving the start signal to a time when the reference time elapsed. The reference signal generation circuit 932 is, for example, a delay circuit or the like. The reference signal generation circuit 932 may include a plurality of circuits for setting a plurality of reference times different from each other. In this case, the reference signal generation circuit 932 may be configured so as to select a specific reference time from the plurality of reference times. Hereinafter, H indicates that the signal level is High, that is, the writing is in execution (BY: busy), and L indicates that the signal level is Low, that is, the writing is stopped (RY: ready).

The write signal generation circuit 933 receives the start signal same as that the reference signal generation circuit 932 receives, and outputs a signal (hereinafter referred to as a write signal) indicating the write time for writing the data into the part of the storage area in the memory cell portion 912. For example, the write signal generation circuit 933 outputs a write signal of which the signal level becomes High when receiving the start signal and the signal level becomes Low when receiving the completion signal.

The comparison circuit 934 receives the reference signal and the write signal, compares the reference signal and the write signal, and determines whether the write signal is longer or shorter than the reference signal. For example, the comparison circuit 934 compares the reference signal from the time of receiving the start signal to the time when the reference time elapsed and the write signal from the time of receiving the start signal to the time of receiving the completion signal. The comparison circuit 934 detects whether the signal level of the write signal is High or Low at the timing when the reference signal level transition from High to Low from the time of receiving the start signal to the time when the reference time has elapsed, and then, determines whether the write signal is longer or shorter than the reference signal. When the signal level of the write signal at this timing is Low, the comparison circuit 934 determines that the write time is shorter than the reference time and outputs the normal signal. On the other hand, when the signal level of the write signal at this timing is High, the comparison circuit 934 determines that the write time is longer than the reference time and outputs the warning signal. The comparison circuit 934 is, for example, a latch circuit, an AND circuit, or the like.

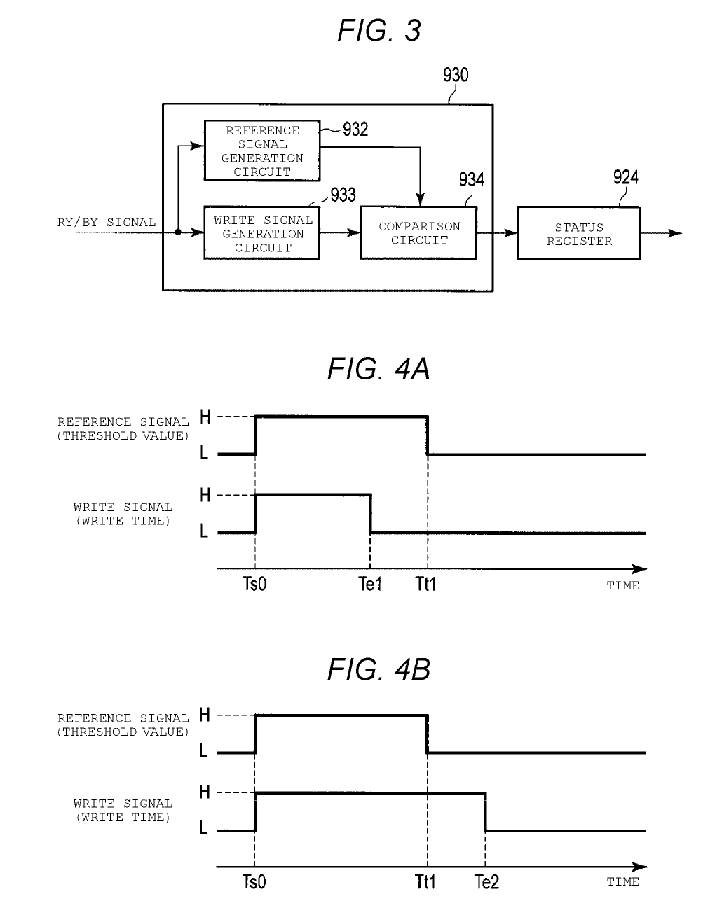

FIG. 3 is a diagram illustrating an example of a configuration diagram for determining the speed of writing the data into the memory cell portion 912 according to the present embodiment.

As illustrated in FIG. 3, in the determination circuit 930, when the writing of the data into the part of the storage area in the memory cell portion 912 is started, the reference signal generation circuit 932 and the write signal generation circuit 933 receives the BY signal as the start signal from the state detection circuit 928 via the control circuit 925 at the same timing. When the BY signal is received, the reference signal generation circuit 932 and the write signal generation circuit 933 respectively outputs the reference signal and the write signal, for example, the reference signal and the write signal of which the signal levels are High to the comparison circuit 934. The reference signal generation circuit 932 outputs the reference signal of which the signal level is Low to the comparison circuit 934 from the time of receiving the BY signal to the time when the reference time has elapsed. When the writing of the data into the part of the storage area in the memory cell portion 912 is completed, the write signal generation circuit 933 receives the RY signal as the completion signal from the state detection circuit 928 via the control circuit 925. When the RY signal is received, the write signal generation circuit 933 outputs the write signal of which the signal level is Low to the comparison circuit 934. At the timing when the signal level of the reference signal transitions from High to Low, the comparison circuit 934 detects whether the signal level of the write signal is High or Low, and then, determines whether the write signal is longer or shorter than the reference signal. When the signal level of the write signal is Low at this timing, the comparison circuit 934 outputs the normal signal to the status register 924. On the other hand, when the signal level of the write signal is High at this timing, the comparison circuit 934 outputs the warning signal to the status register 924. In accordance with the signal received from the comparison circuit 934, the status register 924 stores a status bit indicating whether or not the part of the storage area can be used, in the status corresponding to the part of storage area in the memory cell portion 912 into which the data is written.

FIG. 4A and FIG. 4B are diagrams illustrating examples of timing charts of the reference signal and the write signal. FIG. 4A is a diagram illustrating a timing chart in which the signal level of the write signal is LOW at the timing when the signal level of the reference signal becomes LOW from HIGH, and FIG. 4B is a diagram illustrating a timing chart in which the signal level of the write signal is HIGH at the timing when the signal level of the reference signal becomes LOW from HIGH. In FIG. 4A and FIG. 4B, the reference signal (the threshold value) and the write signal (the write time) are respectively illustrated. In FIG. 4A and FIG. 4B, Ts0 indicates the timing when the reference signal generation circuit 932 and the write signal generation circuit 933 receives the start signal, for example, the BY signal, and Tt1 indicates the timing when the signal level of the reference signal transitions from High to Low. In FIG. 4A, Te1 indicates the timing when the write signal generation circuit 933 receives the completion signal, for example, the RY signal. In FIG. 4B, Te2 indicates the timing when the write signal generation circuit 933 receives the completion signal, for example, the RY signal.

In FIG. 4A and FIG. 4B, when the reference signal generation circuit 932 receives the BY signal from the state detection circuit 928 via the control circuit 925, for example, the signal level of the reference signal transitions from Low to High at the timing Ts0. After elapsing the reference time (=Tt1−Ts0), for example, the signal level of the reference signal transitions from High to Low at the timing Tt1.

In FIG. 4A, when the write signal generation circuit 933 receives the BY signal from the state detection circuit 928 via the control circuit 925, for example, the signal level of the write signal transitions from Low to High at the timing Ts0. When the write signal generation circuit 933 receives the RY signal from the state detection circuit 928 via the control circuit 925, for example, the signal level of the write signal transitions from High to Low at the timing Te1. In the case illustrated in FIG. 4A, the comparison circuit 934 receives the reference signal from the reference signal generation circuit 932 and the write signal from the write signal generation circuit 933, and then, detects that the signal level of the write signal is Low at the timing Tt1. The comparison circuit 934 outputs the normal signal to the status register 924. The status register 924 receives the normal signal from the comparison circuit 934, and stores a status bit (flag data) indicating whether or not the part of the storage area can be used, for example 0, in the status corresponding to the part of storage area in the memory cell portion 912 into which the data is written.

On the other hand, in FIG. 4B, when the write signal generation circuit 933 receives the BY signal from the state detection circuit 928 via the control circuit 925, for example, the signal level of the write signal transitions from Low to High at the timing Ts0. When the write signal generation circuit 933 receives the RY signal from the state detection circuit 928 via the control circuit 925, for example, the signal level of the write signal transitions from High to Low at the timing Te2. In the case illustrated in FIG. 4B, the comparison circuit 934 receives the reference signal from the reference signal generation circuit 932 and the write signal from the write signal generation circuit 933, and then, detects that the signal level of the write signal is High at the timing Tt1. The comparison circuit 934 outputs the warning signal to the status register 924. The status register 924 receives the warning signal from the comparison circuit 934, and stores a status bit indicating whether or not the part of the storage area can be used, for example, 1 in the status corresponding to the part of storage area in the memory cell portion 912 into which the data is written.

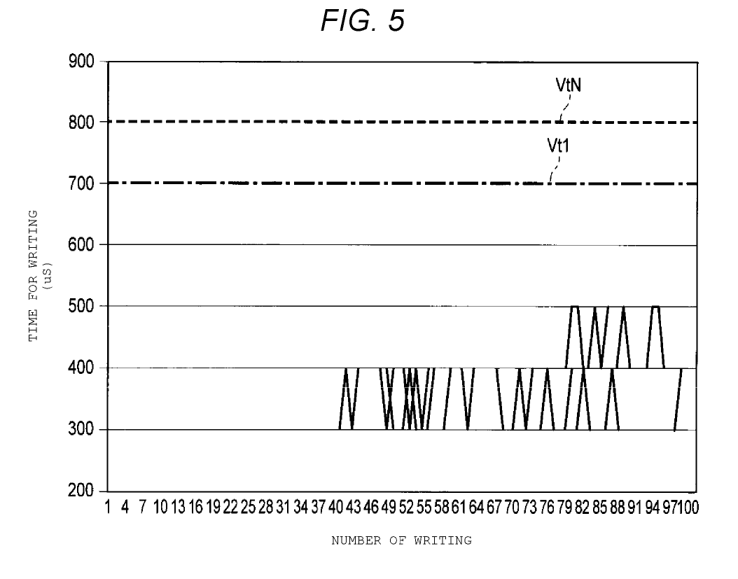

FIG. 5 is a diagram illustrating an example of the speed of writing with respect to the number of writings in one storage area of the memory cell portion 912. In FIG. 5, vertical axis indicates the time (Time Page Program: TPP) (μS) for writing the data in the storage area of one page, that is, the speed of writing the data into the storage area of one page, and horizontal axis indicates the number of writings in the storage area of one page. In FIG. 5, the result of measurements in the plurality of storage areas in the memory cell portion 912 is overwritten. In FIG. 5, as an example, a limit value VtN of the speed of writing at which the writing of the data of one page into the storage area of one page is completed in a maximum allowable time and a reference speed Vt1 at which the writing of the data of one page into the storage area of one page is completed in the reference time. That is, the limit value VtN is a threshold value of an error occurrence in which the data of one page cannot be written into the part of the storage area in the memory cell portion 912. The reference speed Vt1 is a value smaller than the limit value VtN. Therefore, the reference time is a time shorter than the maximum allowable time.

When the writing and erasing of the data into and from the part of the storage area in the memory cell portion 912 are repeatedly executed many times, the memory cells in the memory cell portion 912 are deteriorated. As illustrated in FIG. 5, in proportion to the number of writings of the data into the part of the storage area in the memory cell portion 912, the time for writing the data into the part of the storage area becomes longer. When the time for writing is longer than the limit value VtN, an error occurs in the nonvolatile memory 90, in which the writing of the data having an amount that can be written into the part of the storage area cannot be written within a certain time because the time for writing the data into the part of the storage area in the memory cell portion 912 is too high. In order to prevent such an error, the reference time for writing Vt1 is set lower than the limit value VtN. In the nonvolatile memory 90, by determining whether or not the time for writing the data into the part of the storage area in the memory cell portion 912 reaches the reference time Vt1, it is possible to issue the warning that the storage area is deteriorated before the time for writing reaches the limit value VtN.

In FIG. 1, the system controller (controller) 130 is formed using a large scale integrated circuit (LSI) known as a System-on-a-Chip (SoC) in which a plurality of chips are integrated in a single chip. The system controller 130 includes a read and write (R/W) channel 40, a hard disk controller (HDC) 50, and a microprocessor (MPU) 60.

The R/W channel 40 performs signal processing on the read data and write data. The R/W channel 40 includes a circuit or a function for measuring signal quality of the read data.

The HDC 50 controls the data transfer between the host system 100 and the R/W channel 40 according to an instruction from the MPU 60.

The MPU 60 is a main controller that controls each unit in the storage device 1. The MPU 60 controls the VCM 14 via the driver IC 20 executes a servo-control performing the positioning of the head 15. In addition, the MPU 60 controls the data write operation to the disk 10 and selects a storing destination of the write data transferred from the host 100. Furthermore, when the abnormality occurs in the main power source, the MPU 60 receives the electric power temporarily supplied by the backup power source 21 and executes the operation of saving the volatile data. The operation of saving the volatile data includes, for example, an operation of retracting the head 15 to a position away from the disk 10 and an operation of saving the data using a power loss protection (PLP) function. When the main power source is recovered, the MPU 60 executes an operation of restoring the data.

The MPU 60 includes an area management unit 61, a detection unit 62, and a read and write control unit 63. The MPU 60 executes the processing items of these units on firmware.

When the abnormality occurs in the main power source, the area management unit 61 sets a save area 914 for saving the data stored in the buffer memory 80 in the part of storage area in the memory cell portion 912 in the nonvolatile memory 90. The area management unit 61 manages addresses or the like of the set save area 914 as management information (hereinafter, referred to as area management information) for the storage area in the nonvolatile memory 90.

When a write command to write the data into the part of storage area in the memory cell portion 912 in the nonvolatile memory 90 is received from the host 100, the detection unit 62 reads the status of this storage area from the nonvolatile memory 90 and detects whether or not the warning data is included in the status. When the warning data is included, the detection unit 62 sets a flag on the area management information and this storage area is prohibited from being used. The detection unit 62 maybe configured so as to read the status of the save area 914 in the memory cell portion 912 from the nonvolatile memory 90 only when saving the data into the save area 914 when the abnormality occurs in the main power source and to detect whether or not the warning data is included in the status. In addition, the detection unit 62 may be configured so as to read the status of the save area 914 from the nonvolatile memory 90 at the time of normal operation in which the abnormality does not occur in the main power source and to detect whether or not the warning data is included in the status in advance.

The read and write control unit 63 executes the control relating to the data transmission and reception between the host 100 and each unit in the storage device 1.

When the abnormality occurs in the main power source, the read and write control unit 63 saves the write data which is stored in the buffer memory 80 for which writing has not completed (hereinafter, referred to as unwritten data) and the management information of the unwritten data, in the save area 914 of the nonvolatile memory 90. When the main power source is recovered, the read and write control unit 63 restores the unwritten data saved in the save area 914 in the buffer memory 80 based on the management information of the unwritten data. When the abnormality occurs in the main power source, if there is no vacancy in the capacity of the save area 914, the read and write control unit 63 may set a new save area in the memory cell portion 912 and may save the unwritten data in the new save area. In addition, in this case, the read and write control unit 63 may store the unwritten data in a storage area other than the save area 914 in the memory cell portion 912.

In addition, when writing the data transferred from the host 100 and the data written in the disk 10 in the part of storage area in the memory cell portion 912 in the nonvolatile memory 90, the read and write control unit 63 reads the area management information and determines whether or not the flag is set in the area management information corresponding to the part of storage area in the memory cell portion 912 in the nonvolatile memory 90. When the flag is set, the read and write control unit 63 does not write the data in the storage area where the flag is set, but write the data into another storage area where the flag is not set. The read and write control unit 63 may be configured so as to read the area management information and determine whether or not the flag is set only when saving the data into the save area 914 in the nonvolatile memory 90.

The storage device 1 configured as described above has a function of notifying the host 100 of the completion of writing corresponding to the command even the writing is not actually completed at the time when receiving the write data transferred from the host 100 and the function of managing the unwritten data. In some cases, this function of managing the unwritten data is referred to as, for example, a persistent write cache (PWC) function. When the abnormality occurs in the main power source, the storage device 1 can save the unwritten data and the management information of the unwritten data temporally written in the buffer memory 80, in the nonvolatile memory 90 using the function of managing the unwritten data.

For example, when the abnormality occurs in the main power source during the writing of the write data into the disk 10 from the buffer memory 80, the storage device 1 saves the unwritten data and the management information of the unwritten data temporarily written in the buffer memory 80 into the part of the storage area in the save area 914 in the nonvolatile memory 90 using the electric power supplied by the PLP function. When saving (writing) the data into the part of the storage area in the save area 914, the storage device 1 reads the status corresponding to the part of the storage area. When the warning data is included in the status, the storage device 1 sets a flag on the area management information corresponding to the part of the storage area. When the abnormality occurs in the main power source again after setting the flag, the storage device 1 does not save the data into the part of the storage area in the save area 914 where the flag is set, but saves the data into another storage area in the save area 914 where the flag is not set with reference to the area management information. When the main power source is recovered, the storage device 1 restores the unwritten data saved in the part of the storage area in the save area 914, in the buffer memory 80. As described above, when the unpredicted abnormality occurs in the main power source, the storage device 1 can ensure the saving of the unwritten data within the predetermined data capacity, for example, the data capacity of the save area 914 using the PLP function.

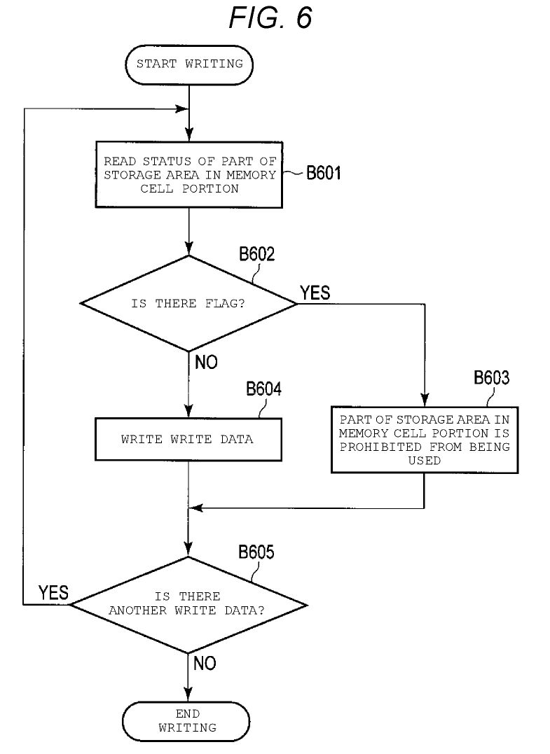

FIG. 6 is a flowchart illustrating an example of writing into the nonvolatile memory 90 in the storage device 1 in the present embodiment.

The MPU 60 reads a status of a part of the storage area in the memory cell portion 912 in the nonvolatile memory 90 via the HDC 50 in response to the reception of the write command from the host 100 (B601). The MPU 60 determines whether or not the warning data is included in the status of this storage area (B602).

When it is determined that the warning data is included (YES in B602), the MPU 60 sets a flag on the area management information corresponding to the part of the storage area in the memory cell portion 912, and this storage area is prohibited from being used (B603). When it is determined that the warning data is not included (NO in B602), the MPU 60 writes the write data into this storage area via the HDC 50 (B604).

The MPU 60 determines whether or not there is another write data to be written into the nonvolatile memory 90 (B605). When it is determined that there is another write data (YES in B605), the MPU 60 executes the processing in B601 again. When it is determined that there is no another write data (No in B605), the MPU 60 ends the writing.

According to the present embodiment, the storage device 1 includes a nonvolatile memory 90 that includes a determination circuit 930 that determines the speed of writing the data into the part of the storage area in the memory cell portion 912 in the nonvolatile memory 90. When it is determined that the speed of writing into the part of the storage area in the memory cell portion 912 in the nonvolatile memory 90 is low, the storage device 1 can prohibit the data from being written in the storage area. Therefore, the storage device 1 can avoid the error occurring in the writing when the abnormality occurs in the main power source. For example, the storage device 1 can avoid the an error occurs in which the writing of the data having an amount that can be written into the part of the storage area cannot be written within a certain time because the speed of writing the data into the part of the storage area in the memory cell portion 912 is low. As a result thereof, the storage device 1 according to the present embodiment can improve the reliability in ensuring the saving of the data. In addition, since the storage device 1 includes the determination circuit 930 in the nonvolatile memory 90, the speed of writing the data into the part of the storage area in the memory cell portion 912 in the nonvolatile memory 90 can be determined without performing the processing using firmware. Furthermore, since the storage device 1 includes the determination circuit 930 in the nonvolatile memory 90, the speed of writing the data into the part of the storage area in the memory cell portion 912 in the nonvolatile memory 90 can be measured with high accuracy.

The storage device 1 reads the status of the storage area in the memory cell portion 912 when the abnormality occurs in the main power source. However, the storage device 1 may read the status of the storage area in the memory cell portion 912 in advance at the time of normal operation in which the abnormality does not occur in the main power source. When the warning data is included in the status, the storage device 1 sets a flag on the area management information corresponding to the part of storage area in the memory cell portion 912 in which the warning data is included. When the abnormality occurs in the main power source after setting the flag, the storage device 1 does not save the data into the part of the storage area in the save area 914 where the flag is set, but saves the data into another storage area in the save area 914 where the flag is not set with reference to the area management information.

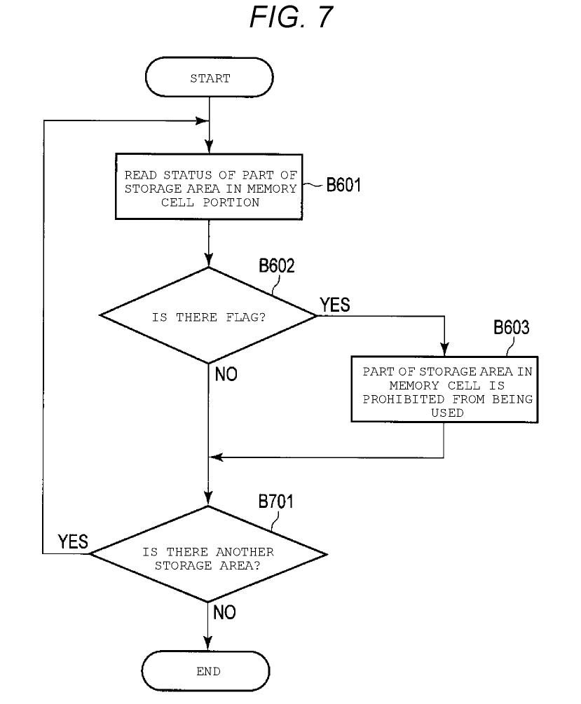

FIG. 7 is a flowchart illustrating an example of determining whether or not the storage area in the nonvolatile memory 90 included in the storage device 1 according to a modification example in the present embodiment is usable. In the flowchart in FIG. 7, the same reference number will be given to the same processing as that in FIG. 6 and the detailed description thereof will be simplified or omitted. The MPU 60 reads a status of a part of the storage area in the memory cell portion 912 in the nonvolatile memory 90 via the HDC 50 at the time normal operation, for example, at the time starting or writing (B601). The MPU 60 determines whether or not the warning data is included in the status of this storage area (B602). When it is determined that the warning data is not included (NO in B602), the MPU 60 determines whether or not there is another storage area in the nonvolatile memory 90 (B701). When it is determined that there is another storage area (YES in B701), the MPU 60 executes the processing in B601 again. When it is determined that there is no another storage area (NO in B701), the MPU 60 ends the writing. Even in this configuration of reading the status in the storage area in the memory cell portion 912 in advance at the time of normal operation, the sufficient effect same as that in the storage device 1 described above can be achieved.

Next, a storage device and a method of writing data into the memory IC in another embodiment will be described. In another embodiment, the same reference number will be given to the same portion as that in the embodiment described above and the detailed description thereof will be omitted.

### Second Embodiment

To the storage device, not limited to the magnetic disk device described in the embodiment described above, another storage device having a nonvolatile semiconductor memory such as a solid state drive (SSD) as a main storage portion can be applied.

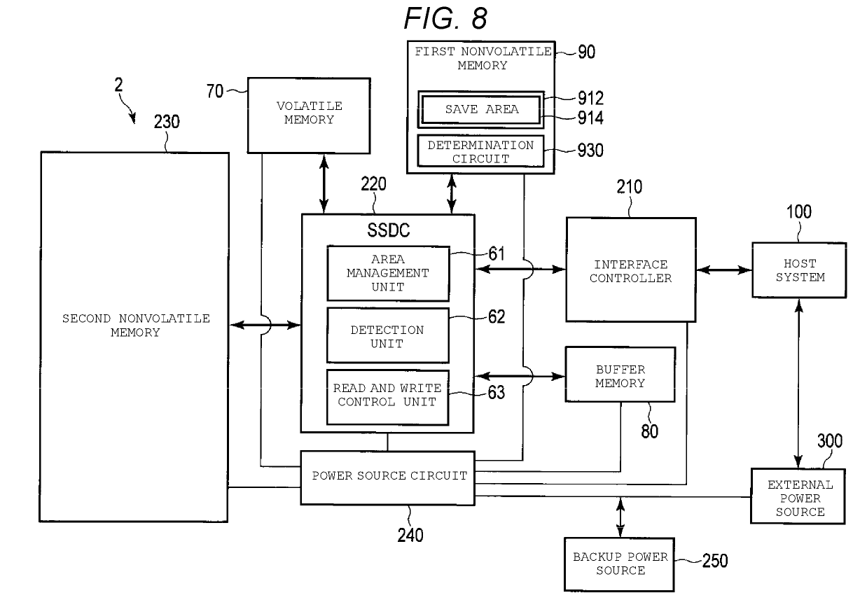

FIG. 8 is a block diagram illustrating a configuration of a storage device 2 according to a second embodiment.

The storage device 2 according to the present second embodiment is, for example, an SSD. The storage device 2 includes an interface controller 210, a volatile memory 70, a buffer memory 80, a nonvolatile memory (hereinafter, referred to as a first nonvolatile memory) 90, an SSD controller (SSDC) 220, a second nonvolatile memory 230, a power source circuit 240, and a backup power source 250. In addition, the storage device 2 is connected to the host 100 and an external power source 300. The first nonvolatile memory 90 is, for example, a NOR type memory. The second nonvolatile memory 230 is, for example, a NAND type memory.

The interface controller 210 executes interfacing between the host 100 and each unit in the storage device 2.

The SSDC (controller) 220 executes various operations of each unit in the storage device 2. The SSDC 220 receives read and write commands from the host 100 and executes the reading and writing in the second nonvolatile memory 230 in response to the commands. The SSDC 220 includes an area management unit 61, detection unit 62, and a read and write control unit 63. That is, the SSDC 220 can execute the operation of the controller 130 that includes the MPU 60 and the HDC 50 in the first embodiment. In addition, when the abnormality occurs in the main power source, the SSDC 220 receives the electric power supplied from the backup power source 250 and executes the operation of saving the volatile data including the PLP function.

The power source circuit 240 outputs the voltage for causing each unit in the storage device 2 to operate based on the voltage supplied from the external power source 300. The backup power source 250 is connected between the power source circuit 240 and the external power source 300. When the storage device 2 normally operates, the backup power source 250 is charged with a part of the electric power supplied from the external power source 300 which is the main power source, and when an abnormality occurs in the external power source 300, the backup power source 250 supplies the electric power necessary for the storage device 2 to save the volatile data. The backup power source 250 includes, for example, a capacitor.

The storage device 2 configured as described above includes a function of managing the unwritten data. For example, when the abnormality occurs in the external power source 300 during the writing of the write data from the buffer memory 80 to the second nonvolatile memory 230, the storage device 2 saves the unwritten data and the management information of the unwritten data stored in the buffer memory 80 in the save area 914 in the first nonvolatile memory 90 using the electric power supplied by the PLP function using the backup power source 250. When saving the data in the in the part of storage area in the memory cell portion 912 in the first nonvolatile memory 90, the storage device 2 reads the status corresponding to this block. When the warning data is included in the status, the storage device 2 sets a flag on the area management information corresponding to this block. When the abnormality occurs again in the external power source 300 after the setting the flag, the storage device 2 does not save the data into the part of the storage area in the save area 914 where the flag is set, but saves the data into another storage area in the save area 914 where the flag is not set with reference to the area management information. When the main power source is recovered, the storage device 2 restores the unwritten data saved in the part of the storage area in the save area 914, in the buffer memory 80. As described above, when the unpredicted abnormality occurs in the main power source, the storage device 2 can ensure the security of the unwritten data within the predetermined data capacity, for example, the data capacity of the save area 914 using the PLP function.

Even the storage device 2 according to the present second embodiment can avoid the error occurring when the high speed writing is required such as a case where the abnormality occurs in the main power source. As a result thereof, the storage device 2 according to the present second embodiment can improve the reliability.

The HDD described in the first embodiment and the modification example and the SSD described in the second embodiment are just examples, and another storage device can be applied.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A storage device comprising:
a nonvolatile memory device that includes a storage area and a circuit configured to measure a write time required for writing data into the storage area and compare the measured write time with a threshold value; and
a controller configured to prohibit data from being written into the storage area in which the measured write time is determined to be longer than the threshold value by the circuit of the nonvolatile memory.

2. The device according to claim 1,
wherein, when the measured write time is determined to be longer than the threshold value, the circuit of the nonvolatile memory stores flag data indicating that the measured write time is longer than the threshold value as status information indicating a state of the storage area, and
wherein the controller reads the status information, and prohibits the data from being written into the storage area when status information includes the flag data.

3. The device according to the claim 1,
wherein the circuit is configured to detect a start signal indicating that writing of data in the storage area has started and a completion signal indicating that the writing of the data in the storage area has completed, and determine whether or not the completion signal is received within a predetermined time from a receipt of the start signal.

4. The device according to claim 3,
wherein the circuit detects a busy signal following a receipt of a write command as the start signal and a ready signal following the busy signal as the completion signal.

5. The device according to claim 1, further comprising:
a volatile buffer memory,
wherein the controller saves the data temporarily stored in the buffer memory in the nonvolatile memory device.

6. The device according to claim 5,
wherein the nonvolatile memory device includes a save area in which the data temporarily stored in the buffer memory is saved, and
wherein the controller saves the data temporarily stored in the buffer memory in the save area.

7. The device according to claim 6, wherein
when it is determined that the write time for writing the data temporarily stored in the buffer memory into the save area is longer than the threshold value, the nonvolatile memory device stores flag data indicating that the write time for writing the data into the save area is longer than the threshold value, as status information indicating the state of the save area, and
wherein the controller is configured to read the status information, and prohibit the data from being written into the save area when the status information includes the flag data.

8. The device according to claim 1,
wherein the threshold value is variable.

9. A nonvolatile memory device comprising:
a storage area; and
a circuit configured to measure a write time required for writing data into the storage area and compare the measured write time with a threshold value.

10. The device according to claim 9, wherein
when the circuit determines that the measured write time is longer than the threshold value, the circuit outputs flag data indicating that the measured write time is longer than the threshold value.

11. The device according to claim 9,
wherein the circuit is configured to detect a start signal indicating that writing of data in the storage area has started and a completion signal indicating that the writing of the data in the storage area has completed, and determine whether or not the completion signal is received within a predetermined time from a receipt of the start signal.

12. The device according to claim 11,
wherein the circuit detects a busy signal following a receipt of a write command as the start signal and a ready signal following the busy signal as the completion signal.

13. The device according to claim 9,
wherein the circuit includes a save area in which data temporarily stored in an external memory, is saved.

14. The device according to claim 13, wherein
when it is determined that the write time for writing the data temporarily stored in the external memory into the save area is longer than the threshold value, the circuit stores flag data indicating that the write time for writing the data into the save area is longer than the threshold value, as status information indicating a state of the save area.

15. The device according to claim 9,
wherein the threshold value is variable.

16. A method of writing data into a nonvolatile memory device of a storage device, the nonvolatile memory device including a storage area and a circuit that measures a write time required for writing data into the storage area and compares the measured write time with a threshold value, the method comprising:
prohibiting data from being written into the storage area in which the measured write time is determined to be longer than the threshold value by the circuit of the nonvolatile memory.

17. The method according to claim 16, further comprising:
reading status information indicating a state of the storage area, and
prohibiting the data from being written into the storage area when the status information includes flag data indicating that the measured write time is longer than the threshold value.

18. The method according to claim 16,
wherein the storage device further includes a volatile buffer memory, the method further comprising:
saving the data temporarily in the buffer memory in the nonvolatile memory device.

19. The method according to claim 18, further comprising:
writing the data temporarily stored in the buffer memory into a save area of the nonvolatile memory device.

20. The method according to claim 19, further comprising:
reading status information indicating the state of the storage area, and
prohibiting the data from being written into the save area when the status information includes flag data indicating that the measured write time is longer than the threshold value.
